(19) United States
(12) Patent Application Publication
(10) Pub. No.: US 2022/0159993 A1
(43) Pub. Date: May 26, 2022

(54) PURIFIED COAGULATED POTATO PROTEIN PRODUCT, METHODS FOR PROVIDING THE SAME, AND USES THEREOF

(71) Applicant: COÖPERATIE KONINKLIJKE AVEBE U.A., Veendam (NL)

(72) Inventors: Maarten Hotse WILBRINK, Groningen (NL); Robin Eric Jacobus SPELBRINK, Schermer (NL); Nikolaos VOGIATZIS, Groningen (NL)

(21) Appl. No.: 17/432,034

(22) PCT Filed: Feb. 21, 2020
(86) PCT No.: PCT/NL2020/050104

§ 371 Date: Aug. 18, 2021

(30) Foreign Application Priority Data
Feb. 21, 2019 (EP) 19158616.3

(51) Int. Cl. A23J 3/14; A23L 19/15

(52) U.S. Cl. CPC A23J 3/14; A23L 19/15

(57) ABSTRACT

The invention relates to the field of food ingredients. In particular, it relates to methods for providing highly purified coagulated potato protein having a desirable taste which is advantageously used for the fortification of food products. Provided is a method for providing a purified coagulated potato protein product, comprising (i) subjecting heat coagulated potato protein to one or more extraction step(s) with an alcoholic extraction solvent comprising (a) ethanol and water at a ratio in the range of 90:10 to 60:40 (v/v), or (b) propanol and water at a ratio in the range of 90:10 to 40:60 (v/v) at a pH in the range of 3 to 6, under conditions allowing for extraction of glycoalkaloids and lipids from said heat coagulated potato protein composition, followed by (ii) washing the extracted heat coagulated potato protein with water to obtain a purified coagulated potato protein product, followed by (iii) drying the purified coagulated potato protein product.

The invention relates to the field of food ingredients, like nutritional protein that allows for the fortification of food products. In particular, it relates to methods for providing highly purified coagulated potato protein powder having a desirable (i.e. neutral) taste. Also provided are coagulated potato protein preparations and uses thereof.

In contrast to functional protein, nutritional protein should have a minimal influence on the food chemistry and rheology of the product that it is used in to allow for a broad applicability. Functional properties other than water binding are undesired. Foaming should in particular be avoided. Ideally, this protein is substantially free from non-protein components and bland (neutral) in taste.

The intrinsic taste impression of potato protein is best described in terms of 4 distinct components that contribute; Odour, basic taste, mouthfeel and flavour. Odour refers to the volatile components of a product that can be perceived by the sense of smell. Basic taste refers to the substances in the mouth that are detected by the taste receptors on the tongue and soft palate that can be distinguished in five basic tastes: sweet, sour, salt, bitter and umami. Mouthfeel refers to the somatosensory signals evoked by a product including irritation, texture and temperature. When a product is eaten, the taste, smell and somatosensory signals (irritation, texture, temperature) of a product together determine the flavour of the product. Therefore it is difficult for humans to distinguish these separate factors. The taste of a product for most humans, actually refers to the overall flavour. More fine-grained evaluation of a food material requires specific sensory evaluation. Sensory evaluation of products can be divided into two types of testing: analytic and hedonic. In analytic testing, sensory attributes of a product are evaluated by a selected or trained panel. Such analysis attempts to quantify distinct attributes of the flavour of a product, either absolutely or relative to a reference product. These attributes may exist at the level of odour, taste or mouthfeel. Common examples of such attributes in the flavour of potato protein are bitterness and saltiness at the level of basic taste; earthiness, cardboard, potato and hay at the odour level, and grittiness, sandiness, hardness and stickiness at the mouthfeel level. In hedonic testing, the reactions of consumers to the sensory properties are measured in terms of liking or disliking. Guidelines for sensory analysis may be found in relevant handbooks such as “Sensory Evaluation of Food, Principles and Practices”.

Potato is an important source for producing nutritional protein. Freshly harvested, it contains about 80 percent water and 20 percent dry matter. About 60 to 80 percent of the dry matter is starch. On a dry weight basis, the protein content of potato is similar to that of cereals and is very high in comparison with other roots and tubers. Potato proteins are particularly rich in lysine whereas sulphur-containing Histidine is the limiting factor of protein quality for children. The three major protein classes are the patatin family, 43 kDa glycoproteins (up to 38 wt % of the potato proteins), the 5-25 kDa protein family of protease inhibitors (up to 50 wt % of all potato proteins) and oxidative and other enzymes having in general higher molecular weights (Pouvreau, L. et al., J. Agric. Food Chem., 2001, 49, 2864-2874).

Potato proteins represent up to 25% of the soluble dry matter of starch factory effluents, and are therefore a major source of pollution. The recovery of potato proteins from waste effluents commonly used is heat coagulation with or without pH adjustment. Coagulated potato protein can be separated from the liquid phase using filters, separators or decanters, yielding wet cake containing 40-80% moisture. The wet cake can subsequently be dried to yield a non-water soluble potato protein with a moisture content between 5-15%. Calculated on a dry substance basis, heat-coagulated potato protein products contain about 70-90% by weight of protein (calculated as N×6.25), about 3-10% by weight of lipids, about 2-4% by weight of carbohydrates and 1-3% by weight of inorganic components.

The separated wet heat-coagulated potato protein and the dried product obtained therefrom contain, in addition to the above-mentioned nutrients, contaminations in the form of sulphite, glyco-alkaloids, water-insoluble polyphenols, organic acids, sugars and lipids. As a result, heat coagulated potato protein tends to suffer from an unpleasant taste. In some cases, these contaminations can present problems in the application of animal feed compositions in which unpurified potato protein products are included as a component.

Glyco-alkaloids consist of carbohydrates which are glycosidically linked to a basic aglycone. In potato protein products, solanine and chaconine are the most important glyco-alkaloids. The total amount of tri-glyco-alkaloids (TGA) in heat-coagulated unpurified potato protein products can vary between 500 and 5000 mg/kg (based on dry substance). It is known that glyco-alkaloids can give rise to poisoning symptoms upon consumption by humans or animals. Solanine possesses a direct toxicity due to its choline-esterase inhibiting action in the central nervous system. If the glyco-alkaloid content in animal feeds is too high, undesired phenomena can occur, such as feed refusal and retardation of growth. In addition, solanine has a bitter taste and gives a burning sensation upon consumption.

Potato lipids mostly concern phospho- and glycolipids. The fatty acids are predominantly linoleic and linolenic acid. Accurate lipid measurements in potato is technically challenging in view of the rapid degradation of lipids. Pun et al. (Potato Res. 1980, 23, 57-74) provides an overview of potato lipids. In the absence of precautionary measures to prevent lipid degradation, potato lipids are found to contain 63.4% phospholipids, 21.3% glycolipids, 7.8% triglycerides and 9.1% free fatty acids. The combined presence of lipases and oxidases in potato juice typically causes in a significant degree of lipid degradation and oxidation. The resulting degradation and oxidation products are thought to represent at least some of the “contaminants” giving rise to an unpleasant taste and odour of the coagulated potato protein product.

Efforts have been made in the art to remove at least some of the contaminants from coagulated potato protein. For example, WO2017/142406 in the name of the applicant discloses a process wherein coagulated potato protein is extensively washed with low conductivity water to remove “sticky components” such as sugars, organic acids and amino acids to yield a material which is less “keratinized” or “horny”. However, this process does not remove components which contribute to the bitter off-taste and/or unpleasant odour of heat coagulated potato protein.

Other attempts involving washing steps are disclosed in DE2814922C2 and in EP0700641A2, each using distinct approaches to overcome the inherent difficulties in removing lipids from coagulated potato protein. The inventors of DE2814922C2 ascribe these difficulties to the formation of a hardened, “keratinized” or “horn-like” layer around the protein particles that can only be overcome by extracting the lipid from the protein at temperatures above the atmospheric boiling point of the solvent, the boiling of which is prevented by pressurization.

EP0700641A2 follows a different procedure in which the protein particles are grinded into exceedingly fine powders. In the presence of organic solvents, applying up to 50% EtOH in a first extraction step and reducing the particle size in the presence of neutral to alkaline aqueous alcoholic solvent in a second extraction step, the fine powders improve the lipid extraction and form a finely dispersed substrate for hydrolysis of the insoluble protein into water-soluble peptides. However, the formation of soluble peptides is unwanted because hydrolysed proteins tend to have a negative impact on taste as peptides are perceived as bitter. Moreover, extensive processing results in an increase of the costs.

The inventors therefore set out to develop an improved method for purifying coagulated potato protein. In particular, they aimed at removing at least TGA and lipids from coagulated potato protein in an economically feasible manner. For example, the process contains a minimal amount of steps, it can be performed under ambient conditions (temperature, pressure etc.) and does not involve pulverization, and/or the use of harmful solvents, such as the carcinogenic solvent hexane. Ideally, the resulting potato protein product has a palatable taste, is high in protein (e.g. >87%), very low in TGA (e.g. below 100 ppm on DS) and lipids (e.g. less than 1% on DS).

It was surprisingly found that at least some of these goals could be met by washing or extracting coagulated potato protein with specific aqueous mixtures of an aliphatic alcohol in water under acidic conditions. More in particular, both the glycoalkaloid and crude fat levels were efficiently reduced to less than 150 ppm TGA and less than 1.5% (on DS) lipids upon extraction with 60-90v % ethanol or 40-90 v % (iso)propanol in water.

Accordingly, in one embodiment, the invention provides a method for providing a purified coagulated potato protein product, comprising the steps of (i) subjecting a heat coagulated potato protein composition to one or more extraction step(s) with an alcoholic extraction solvent comprising ethanol and water at a ratio in the range of 90:10 to 60:40 (v/v), or propanol and water at a ratio in the range of 90:10 to 40:60 and having a pH in the range of 3 to 6, under conditions allowing for extraction of glycoalkaloids and lipids from said heat coagulated potato protein composition, followed by (ii) washing the extracted heat coagulated potato protein composition with water to obtain a purified coagulated potato protein product, followed by (iii) drying the purified product to obtain a purified coagulated potato protein product.

The invention also relates to a method for removing glycoalkaloids and lipids from a coagulated potato protein product, comprising the steps of (i) subjecting a heat coagulated potato protein composition to one or more extraction step(s) with an alcoholic extraction solvent comprising ethanol and water at a ratio in the range of 90:10 to 60:40 (v/v), or propanol and water at a ratio in the range of 90:10 to 40:60, at a pH in the range of 3 to 6, under conditions allowing for extraction of glycoalkaloids and lipids from said heat coagulated potato protein composition, followed by (ii) washing the extracted heat coagulated potato protein composition with water to obtain a purified coagulated potato protein product, followed by (iii) drying the purified product to obtain a purified coagulated potato protein.
In one aspect, the invention provides a purified coagulated potato protein product containing less than 150 ppm TGA and less than 1.5% (on DS) lipids.
A method of the invention is not taught or suggested in the art.

NL7612684 relates to the use of lipid solvents to remove lipids from potato juice and from coagulated potato protein. Lipid solvents include methylene chloride, chloroform and C1-C5 aliphatic alcohols. Nothing is mentioned about adjusting the extraction solvent or the extraction mixture to pH 3-6. Moreover, NL7612684 is silent about any TGA removal. On the contrary, since it aims to produce an extract of potato lipids, rather than producing a lipid-depleted potato protein, TGA extraction from the potato protein would be undesired.

DE2814922C2 discloses the boiling under elevated pressure of a suspension of potato protein coagulate in at least 70 w % of an organic polar solvent, e.g. ethanol, in order to extract lipid-like compounds having an unpleasant taste. Like in NL7612684, the coagulate is treated “as such”, and nothing is mentioned about performing the extraction in the range pH 3-6. Straetkvern et al. (Bioseparation 1999, 7 (1), 333-345) report a pH of 6.4 for crude potato tuber juice. Thermal coagulation of potato protein will inherently yield a coagulated potato protein with the same or a highly similar pH.

NL7500083 provides a method for obtaining coagulated potato proteins from potato juice with purity and improved properties compared to the proteins known in the art. Flocculation of proteins is accomplished at pH 4.6-5.1 and the temperature is 80-140° C. in the presence of SO₂ Solanine, which is a TGA, is extracted by re-suspending the coagulated potato protein in an aqueous solution containing 0.05-5% acids or using an organic solvent, e.g. isopropanol, at the boiling temperature of the solvent. No aqueous mixtures of alcohol and water are taught or suggested. The final fat content of a potato protein product obtained by a method according to NL7500083 is above 2 wt. %.

Preferably, steps (i), (ii) and (iii) of a method according to the invention are performed on heat coagulated potato protein having a mean particle size distribution (d50) of at least 20 μm, preferably on coagulated potato protein having a d50 between 20 and 300 μm, more preferably between 25 and 250 μm, even more preferably between 30 and 200 μm, as determined on a dry product. In particular, a method of the invention up to and including the drying step preferably does not comprise (mechanical) particle size reduction, pulveration, pounding, grinding, or the like.

The d10, d50 and d90 values are common parameters to express particle size distribution. The d50 (also referred to as Dv50) is the volume median particle size, and indicates the diameter, in μm, that splits the distribution into two equal fractions, wherein half of the particle volume has a diameter above the median diameter, and wherein half of the particle volume has a diameter below the median diameter. Similarly, the d10 indicates the diameter, in μm, that splits the particle size distribution into two (volume) portions, wherein 10% of the particle volume has a diameter below the d10, and wherein 90% of the particle volume has a diameter above the d10. The d90 is defined in a similar manner, and indicates the diameter that splits the particle size distribution into two (volume) portions, wherein 90% of the particle volume has a diameter below the d90, and wherein 10% of the particle volume has a diameter above the d90.

Accordingly, in one embodiment, a purified coagulated protein product provided by a method of the invention is characterized by a d10 between 5 and 70 μm preferably between 10 and 60 μm, more preferably between 12 and 50 μm, as determined on a dry product. It is further characterized by a d50 between 20 and 300 μm, preferably between 25 and 250 μm, more preferably between 30 and 200 μm, as determined on a dry product. The protein material is further characterised by a d90 between 60 and 600 μm, preferably between 150 and 500 μm, more preferably between 200 and 450 μm, as determined on a dry product.

Still further, a purification method provided herein does not comprise adjusting the pH of a coagulated potato protein product to the alkaline range, e.g. pH 6.5 or higher. This avoids the formation of components that give the final product an unpleasant taste, presumably via formation of off flavours due to Maillard reactions between protein and sugars, oxidation at high pH of phenolic acids and at pH above 9, hydrolysis of proteins leading to peptide formation, and/or the formation of Lysino-alanine, pyrolysis of sugars and de-amination reactions.

This is in contrast to potato protein purification methods disclosed in the art, such as EP0700641, involving multiple extraction steps, some of which are performed on small (1-14 μm) particles and at alkaline pH.

According to the present invention, the potato protein starting material can be any type of heat coagulated potato protein preparation. Typically, potato protein is obtained as a by-product in the recovery of potato starch from potatoes. In the potato starch manufacture, using mechanical separation techniques, the potato is processed into potato starch, potato pulp and potato juice, also referred to as potato fruit juice (PFJ), potato liquor or waste. In the potato juice, the potato protein molecules are present in dissolved condition. There are various possibilities of isolating the potato protein from the potato juice in a more or less pure state. Usually, the potato juice is subjected to a heat treatment, as a result of which the potato protein molecules start to coagulate. This method is designated as heat coagulation or thermal coagulation.

Typically, heat coagulated potato protein is obtained by methods known in the art comprising subjecting a potato (waste) juice to heat, for a time long enough to coagulate the protein. This may be achieved by subjecting the protein to a temperature of at least 70° C., preferably at least 80° C., more preferably at least 90° C. or even to a temperature of 100° C. or even more, for a period of several minutes, preferably at least 30 minutes, more preferably at least 1 hr, even more preferably at least 2 hrs, such as for instance 30 min-5 hr or 1-4 hr. The higher the temperature, the shorter the time required for coagulation. In a preferred embodiment, coagulation is achieved at a temperature of 100-110° C., for a period of 1-60 seconds, for example at a pH of 4.5-6.

The thus-coagulated flocculent potato protein material can be separated from the liquid phase by means of filters, separators or decanters, yielding a separated wet potato protein product in the form of a wet cake. This product still contains 40-80% by weight of moisture and can subsequently be dried to 5-15% by weight of moisture. Following protein coagulation, the potato protein is preferably dried to yield a coagulated potato protein composition comprising up to 15wt % moisture, more preferably up to 10 wt % moisture. In a specific aspect, the heat coagulated potato protein starting material is a powder.

Calculated on a dry substance basis, heat-coagulated potato protein products generally contain about 70-90% by weight of protein (calculated as N×6.25), about 3-10% by weight of lipids, about 2-4% by weight of carbohydrates and 1-3% by weight of inorganic components.

In a specific embodiment, a method of the invention uses as starting material a heat coagulated potato protein product that is obtained according to EP0839003. Therein, potato juice-separated heat-coagulated potato protein or the dried product obtained therefrom is treated with one or more aqueous solutions of one or more inorganic acids. Preferred inorganic acids include phosphoric acid, hydrochloric acid, sulphuric acid or combinations of these acids.

In a method of the invention, a heat coagulated potato protein is subjected to one or more extraction step(s) with an extraction solvent comprising ethanol and water at a ratio in the range of 90:10 to 60:40 (v/v), or propanol and water at a ratio in the range of 90:10 to 40:60, and having a pH in the range of 3 to 6, under conditions allowing for extraction of glycoalkaloids as well as lipids from said heat coagulated potato protein. To that end, protein coagulate is suitably suspended into the defined alcoholic extraction solvent according to the present invention. For example, heat coagulated potato protein is mixed with extraction solvent at a concentration of about 30-200 g/L, preferably 80-150 g/L, most preferably 90-110 g/L.

The extraction solvent comprises water and a C₂-C3 alcohol, i.e. water and ethanol or propanol (iso-propanol or n-propanol). Combinations of two or more alcohols are also encompassed.

In one embodiment, the extraction solvent comprises (a) ethanol and water, or (b) propanol and water, at an alcohol/water ratio in the range of 90:10 to 40:60 (v/v), preferably 90:10 to 50:50 (v/v), more preferably 85:15 to 60:40 (v/v).

Good results are obtained with an extraction solvent comprising ethanol (EtOH), 1-propanol, 2-propanol (isopropanol; IPA) or a mixture thereof. In a preferred embodiment, the extraction solvent comprises ethanol and water, preferably ethanol and water at a ratio in the range of 90:10 to 60:40 (v/v), preferably 85:10 to 60:40 (v/v) preferably 85:15 to 70:30 (v/v). For example, the extraction solvent is 60%, 65%, 70%, 75%, 80% or 85% EtOH in water.

In another embodiment, the extraction solvent comprises IPA as alcohol, preferably as sole alcohol. In a preferred embodiment, the extraction solvent comprises IPA and water at a ratio in the range of 90:10 to 40:60 (v/v), preferably 80:10 to 50:50 (v/v), preferably 70:30 to 50:50 (v/v). For example, the extraction solvent is 40%, 45%, 50%, 55%, 60%, 65%, 70%, 75%, 80% or 85% IPA in water.

Alternatively, the extraction solvent is 40-90% 1-propanol in water. For example, the extraction solvent is 40%, 45%, 50%, 55%, 60%, 65%, 70%, 75%, 80% or 85% 1-propanol in water.

In yet another embodiment, the extraction solvent comprises both IPA and EtOH, wherein the total alcohol concentration is 40-90% in water. For example, the extraction solvent is 40%, 45%, 50%, 55%, 60%, 65%, 70%, 75%, 80% or 85% (IPA+EtOH) in water.

Then, the suspension of potato protein coagulate in extraction solvent is brought to the desired pH in the range of 3 to 6. Good extraction results are obtained at pH 4-6, preferably pH 4-5. Suitable acids for adjusting the pH include hydrochloric acid, sulfuric acid, phosphoric acid, citric acid, lactic acid, acetic acid and formic acid.

After setting the pH to the required value, the suspension may be heated to the desired extraction temperature. In one embodiment, the extraction is performed at a temperature below the boiling point of the alcohol/water mixture. Preferably, it is performed in the range of 20 to 70° C., more preferably in the range of 20 to 60° C. In a specifically preferred embodiment, a method of the invention is performed at mild e.g. ambient, temperature since this is most simple and cost effective. However, extraction is generally more effective at elevated temperatures, especially when using a relatively short extraction period. Preferably the extraction is performed with 60-90% (v/v), preferably 60-85% (v/v), alcohol in water at pH 4-5 at 20-50° C.

The at least one extraction step is performed for the designated period of time, preferably under stirring. A method provided herein may comprises at least two consecutive extraction steps. If two or more consecutive extraction steps are desired, the first extraction step is suitably completed by centrifugation and removal of the first volume of extraction solvent. The residue is then resuspended into a second volume of extraction solvent, which may but does not need to be the same solvent mixture at the same concentration and extracted at the same conditions. This process can be repeated until the desired degree of purification is obtained. According to the invention, the extraction step(s) may be performed in a continuous process or in a batch wise process. In one embodiment, extraction is performed in co-current flow, cross-flow or counter current flow.

The extraction phase is followed by washing the extracted heat coagulated potato protein composition with water to obtain a purified coagulated potato protein product, followed by drying the purified product to obtain a purified coagulated potato protein product.

For example, the suspension is centrifuged again and the final volume of extraction solvent is removed, after which the purified potato protein is washed by resuspension into (tap) water to remove any remaining alcohol, stirred e.g. for at least 1 hour, centrifuged and dried.

A further embodiment of the invention relates to a purified coagulated potato protein product obtainable or obtained by a purification method according to the invention. Such product is among others characterized by a low triglycoalkaloid (TGA) content, and the presence of only a minor amount of lipids. Provided is for example a purified coagulated potato protein product that contains less than 100 ppm triglycoalkaloid

(TGA) on dry solids, preferably less than 80 ppm TGA, more preferably less than 50 ppm TGA. The purified coagulated potato protein product is furthermore characterized in that it contains less than 1.5% of lipids, preferably less than 1.0% lipids, more preferably less than 0.5% of lipids. In one aspect, it contains less than 0.3% of lipids, preferably less than 0.2% lipids, more preferably less than 0.1% lipids. The purified coagulated potato protein product is further characterised by a low solubility in water. As a result, a purified coagulated potato protein product provided herein has a palatable and neutral taste.

The invention therefore also provides the use of an alcoholic extraction solvent comprising (a) ethanol and water at a ratio in the range of 90:10 to 60:40 (v/v), or (b) propanol and water at a ratio in the range of 90:10 to 40:60 (v/v) to improve the flavour or taste of a heat coagulated potato protein preparation. In one embodiment, the alcoholic extraction solvent is used to reduce the bitter and/or astringent taste of a heat coagulated potato protein preparation. The preferences for the alcoholic solvent mixture as disclosed herein above are applicable for such use.

The inherent difficulties in removing lipid material from coagulated potato protein limit the repertoire of methods that can be applied to the quantification of lipid residues. Reliable analysis of the amount of lipid material can be performed by hydrolysing the ester bond between a lipids' glycerol moiety and the fatty acid chains' carboxyl group, followed by apolar extraction and gravimetry of the liberated fatty acid.

A purified potato protein product of the invention is additionally characterized by a high protein content, thus ensuring a good applicability as protein source e.g. in the manufacture of a food item. In one embodiment, the purified coagulated potato protein product has a protein concentration (based on dry solids) of at least 88%, preferably at least 89%, more preferably at least 90%, as determined by Kjeldahl.

In one embodiment, a purified coagulated potato protein product according to the invention is characterized by the following particle size distribution (as determined on a dry product):
a d10 between 5 and 70 μm preferably between 10 and 60 μm, more preferably between 12 and 50 μm,
a d50 between 20 and 300 μm, preferably between 25 and 250 μm, more preferably between 30 and 200 μm, and/or
a d90 between 60 and 600 μm, preferably between 150 and 500 μm, more preferably between 200 and 450 μm.

The person skilled in the art will appreciate that a purified coagulated potato protein product of the invention has a diverse range of industrial applications. As indicated herein above, it is advantageously used in the manufacture of a food item, preferably a human food item, more preferably a beverage or texturized protein product.

In the preparation of a food item, the purified protein product of the invention may be used without further modifying the particle size or particle size distribution. Typically, the d-50 is above 20 μm and less than 75 μm. Since extrusion techniques require a sufficiently high particle size to be susceptible to this form of processing, a potato protein coagulate of the present invention may be agglomerated prior to extrusion e.g. in order to prepare a textured food item. In one embodiment, the purified potato protein coagulate for application in a texturized product has a particle size with a d50 in the range 100 to 250 μm. For example, the purified potato protein product is incorporated in a food item comprising texturized protein, including snacks e.g. protein crisps.

For other applications, the particle size is preferably lower to avoid the sensation of grittiness that often occurs with ingestion of heat-coagulated protein. Potato protein powders having a defined particle size distribution may also be obtained by subjecting a purified potato protein coagulate to other known (fractionation) techniques in the art, including sieving or wind sifting.

For beverage applications, the purified potato protein of the invention may be grinded to obtain a particle size d-50 in the range of about 20 to 30 μm. Accordingly, also provided is a food item comprising purified coagulated potato protein product as herein disclosed.

### EXPERIMENTAL SECTION

Method: Washing coagulated potato protein with alcohols on the laboratory scale. A typical heat coagulated potato protein product, derived from a single batch, was used as starting material in a purification method involving a variety of different extraction regimes. This batch was produced essentially as described in EP0839003 B1, page 1, lines 22-31, and marketed by Avebe under the trade name Protamyl as potato protein for feed. A particular batch used for the experiments was characterized by a dry solids (DS) content of 91.5%, a protein content of 83.4% on DS, a TGA content of 1774 ppm and a lipid content of 3.0% on DS.

All protein extraction and washing steps were carried out in 0.5 L glass bottles, using a sample volume of 400 ml, with a protein solid content of 90-120 g/L, unless indicated otherwise. Each experiment involved one or two consecutive wash steps, where the alcohol-to-water ratio was indicated as vol:vol. pH values of the suspensions were adjusted to the appropriate levels using either 5 M HCl or NaOH as recorded by a freshly calibrated pH meter (WTW Inolab).

Alcohols were either isopropanol (GPR RECTAPUR®, VWR Chemicals), 1-propanol (EMPLURA®, Merck) or ethanol (Technisolv, VWR).

The temperature of the extractions was controlled in a temperature-controlled shaking water bath. Following the one or two alcohol/water washing steps, either one or two final washing steps were done with water, at a protein concentration of 10 wt. % in demi water, which was then incubated for at the same temperature as the alcohol/water washing steps, resulting in totally three washing steps. After each washing step, the protein solids were recovered by centrifugation in a Heraeus Multifuge 1S-R (10 min at 4,000 rpm at room temperature) and the liquid was removed by decanting. Washed protein products were dried in a stove for 2-3 days at 50° C., until a moisture content of <10% was reached. The obtained protein powders were subjected to crude lipid, TGA and protein analyses, as described in the methods section. The analytical values reported are all calculated as percentage or mg/kg (ppm) based on dry matter.

Analysis of the composition of the protein products was done according to standard procedures.

TGA levels were determined by online SPE-HPLC as described by Laus et al., (Laus et al, Food Anal. Methods 2017, 10, 845-853; Improved extraction and sample clean up of tri-glycoalkaloids α-solanine and α-chaconine in non-denatured potato protein isolates. https://doi.org/10.1007/s12161-016-0631-2), using commercial standards of α-solanine (Sigma-Aldrich, Germany) and α-chaconine (Carl Roth GmbH, Germany).

Crude fat (lipids) content was determined by Soxhlet extraction after acid hydrolysis, using petroleum ether and gravimetric detection (according to EG 152-2009).

Dry solid contents were determined by thermogravimetry, using a Mettler Toledo HR83 Moisture Analyzer device.

Protein contents were determined by Kjeldahl nitrogen analysis, essentially as described in ISO 3188:1978, using L-tryptophan as standard. The conversion factor used was N*6.25.

The experimental conditions and the resulting compositions are shown in the following examples.

### EXAMPLE 1

### Influence of pH on Extraction Efficiency

This example shows that by using 100% IPA in a purification method at ambient temperature according to NL7500083, lipids are removed only partially and the TGA level is still much too high. It further shows that by using a mixture of IPA and water and adapting the pH of the extraction solvent according to the present invention, both the extraction of lipids and TGA can be optimised. The results are shown in Table 1. At 60% IPA, optimised conditions were found at pH 4-5.

TABLE 1

| | | | | | | TGA | |
|---|---|---|---|---|---|---|---|
| | | | | | Kjeldahl N | ppm | crude fat |
| protein | pH | % IPA | temp | % DS | % on DS | on DS | % on DS |
| Protamyl | As is | 100 | ambient | 94.2 | 84.6 | 998 | 2.1 |
| Protamyl | As is | 90 | ambient | 92.3 | 88.5 | 584 | 0.2 |
| Protamyl | 3 | 90 | ambient | 95.2 | 89.0 | 90 | 0.1 |
| Protamyl | 3 | 60 | ambient | 96.3 | 84.9 | 64 | <0.1 |
| Protamyl | 4 | 60 | ambient | 95.0 | 88.1 | 27 | <0.1 |
| Protamyl | 5 | 60 | ambient | 94.8 | 88.7 | 23 | <0.1 |
| Protamyl | 6 | 60 | ambient | 95.8 | 91.3 | 71 | 0.2 |

### EXAMPLE 2

### Influence of Alcohol/Water Ratio on Extraction Efficacy

Table 2a shows the influence of the alcohol/water ratio of the extraction solvent when extractions are performed at pH 3. At 30% IPA, TGA is removed efficiently, but lipids are not. At 60% IPA, both TGA and lipids are extracted efficiently. At 90% IPA, the efficacy of TGA removal reduces again.

TABLE 2a

| | | | | | | TGA | |
|---|---|---|---|---|---|---|---|
| | | | | | Kjeldahl N | ppm | crude fat |
| protein | pH | % IPA | temp | % DS | % on DS | on DS | % on DS |
| Protamyl | 3 | 30 | ambient | 95.6 | 83.7 | <14 | 3.1 |
| Protamyl | 3 | 60 | ambient | 96.3 | 84.9 | 64 | <0.1 |
| Protamyl | 3 | 90 | ambient | 95.2 | 89.0 | 88 | 0.1 |

Table 2b shows the influence of the alcohol/water ratio when extractions are performed at pH 6. Above 40% IPA, both TGA and lipid extraction are performed efficiently. At 90% IPA, the upper limit regarding efficient removal of TGA is achieved.

TABLE 2b

| | | | | | | TGA | |
|---|---|---|---|---|---|---|---|
| | | | | | Kjeldahl N | ppm | crude fat |
| protein | pH | % IPA | temp | % DS | % on DS | on DS | % on DS |
| Protamyl | 6 | 30 | ambient | 94.6 | 86.7 | 151 | 1.9 |
| Protamyl | 6 | 40 | ambient | 96.0 | 88.9 | 96 | 1.5 |
| Protamyl | 6 | 50 | ambient | 94.2 | 92.0 | 86 | 0.4 |
| Protamyl | 6 | 60 | ambient | 95.8 | 91.3 | 71 | 0.2 |
| Protamyl | 6 | 90 | Ambient | 92.3 | 88.5 | 284 | 0.2 |

Table 2c shows the influence of the alcohol/water ratio when extractions are performed at optimised pH 4. Similarly to pH 6, extraction mixtures comprising at least 40% IPA are advantageously used for efficient removal of both lipids and TGA.

TABLE 2c

| | | | | | | TGA | |
|---|---|---|---|---|---|---|---|
| | | | | | Kjeldahl N | ppm on | crude fat |
| protein | pH | % IPA | temp | % DS | % on DS | DS | % on DS |
| Protamyl | 4 | 40 | ambient | 96.0 | 87.7 | 30 | 1.4 |
| Protamyl | 4 | 60 | ambient | 95.0 | 88.1 | 27 | <0.1 |

### EXAMPLE 3

### Influence of Temperature on Extraction Efficacy

Table 3 shows that at increased temperature, similar results were obtained confirming the excellent extraction conditions to remove TGA and lipids from potato protein when using a mixture of IPA and water at 60% IPA at pH 4 to 5.

TABLE 3

| | | | | | | TGA | |
|---|---|---|---|---|---|---|---|
| | | % | | | Kjeldahl N | ppm on | crude fat |
| protein | pH | IPA | temp | % DS | % on DS | DS | % on DS |
| Protamyl | 6 | 60 | ambient | 95.8 | 91.3 | 71 | 0.2 |
| Protamyl | 6 | 60 | 50° C. | 92.3 | 91.9 | 72 | <0.1 |
| Protamyl | 5 | 60 | 50° C. | 93.6 | 90.1 | 26 | <0.1 |
| Protamyl | 3 | 60 | 50° C. | 95.5 | 86.1 | 68 | <0.1 |
| Protamyl | 3 | 30 | 80° C. | 96.7 | 80.7 | <14 | 2.4 |
| Protamyl | 6 | 30 | 50° C. | 92.7 | 88.1 | 116 | 1.7 |
| Protamyl | As is | 100 | 70° C. | 93.3 | 87.0 | 905 | 0.5 |

As can be derived from Table 3, despite the elevated temperature, 100% IPA still does not remove TGA and lipid to the desired levels. Again, 30% IPA solvents indicate the lower concentration range as also at higher temperatures this does not remove TGA and more specifically lipid to the desired levels.

### EXAMPLE 4

### Influence Other C₁-C₄ Alcohols on Extraction Efficacy

Table 4 demonstrates that aqueous mixtures with C₁-C₃ alcohols other than IPA also result in the desired reduction in both TGA and lipid content.

TABLE 4

| | | | | | | TGA | |
|---|---|---|---|---|---|---|---|
| | | 60% | | | Kjeldahl N | ppm | crude fat |
| protein | pH | Solvent | temp | % DS | % on DS | on DS | % on DS |
| Protamyl | 6 | Ethanol | ambient | 95.8 | 89.4 | 62 | 0.8 |
| Protamyl | 6 | 1-propanol | ambient | 96.0 | 91.5 | 52 | <0.1 |
| Protamyl | 6 | IPA | ambient | 95.8 | 91.3 | 71 | 0.2 |

### EXAMPLE 5

### Extraction Using EtOH/Water Extraction Solvent

The effect of a single extraction with an extraction solvent consisting of 60, 70, 80 or 90 v % in water on the removal of fat (lipids) and TGA was assessed. Also, a single and a double extraction with EtOH/water (50:50% by volume) was performed (comparative example). All tests were carried out at pH 6 and at ambient temperature. Protamyl containing 1176 ppm TGA and 2.2 wt % lipids (fat) was used as starting material. The results are shown in Table 5.

TABLE 5
Overview of the effect of ethanol % on fat and TGA removal and
total protein content. All tests consisted of one or two consecutive
ethanol/water extraction steps, followed by one or two water wash
steps (1 h each).

| | | | | | | TGA | | fat |
|---|---|---|---|---|---|---|---|---|
| | % | | % | | TGA | % | fat | % |
| protein | EtOH | steps | DS | P %^{DS} | ppm^{DS} | removal | %^{DS} | removal |
| Protamyl | 50 | 1 | 94.0 | 84.4 | 114 | 90 | 2.2 | 0 |
| Protamyl | 50 | 2 | 90.7 | 89.0 | 53 | 95 | 1.7 | 24 |
| Protamyl | 60 | 1 | 93.2 | 88.4 | 118 | 90 | 1.1 | 50 |
| Protamyl | 70 | 1 | 92.4 | 88.6 | 130 | 89 | 0.2 | 90 |
| Protamyl | 80 | 1 | 92.6 | 88.5 | 134 | 89 | <0.1 | >95 |
| Protamyl | 90 | 1 | 92.8 | 89.3 | 197 | 83 | 0.1 | 95 |
| Protamyl | as is | | 90.0 | 82.2 | 1176 | — | 2.2 | — |

No fat removal was measured after extraction with 50v % ethanol in water, At 60v %, the performance was increased, while at 70v % and higher, a single extraction step was sufficient to remove fat to the desired level of 0.2% or lower. The efficiency of fat removal increased with ethanol concentration and was optimal at 80%.
Regarding TGA removal, the ethanol concentrations had very similar performance for the range of 50-80%; all removed 89-90% of the TGA, while washing with 90v % ethanol gave a slightly worse performance. A single ethanol wash at 50-80v % was enough to reach a TGA level below 150 ppm, but only with a EtOH-to-water ratio in the range of 90:10 to 60:40 both the TGA and lipid content were reduced to a desirable level.

### EXAMPLE 6

### Particle Size Distribution of Representative Starting Materials and Purified Potato Protein Coagulates

This example illustrates the typical particle size distribution of representative starting material, as well as that of purified potato protein coagulates obtainable by an extraction method of the invention.

Extractions were performed using an alcoholic extraction solvent as described in the Experimental section herein above, except that all extractions were carried out at a larger scale in 5 L glass beakers equipped with stirrer at sample volumes of 2.5 L and a protein solid content of 100 g/L. After two consecutive extraction steps of 1 hour each at pH 6 and ambient temperature using the alcohol/water extraction solvent, a final washing step with water during 1 hour at a protein solid concentration of 100 g/L was performed.

The washed protein products were resuspended in tap water to a dry solid concentration of 10 wt % and subsequently dried with an Anhydro Compact spray drier (Copenhagen, Denmark) using a rotary disk nozzle at a rotating speed of 30.000 rpm. The inlet temperature is 175° C. and the outlet temperature was 75° C. The particle size distribution (PSD) of the final dried powder was assessed in either the dry and wet state. Every PSD value shown in the tables below is the result of two measurements.

Particle size distribution of starting material, intermediate or final product was determined using laser diffraction, and the particle size data were calculated with the Frauenhofer method. The software used for performing this calculation is WINDOX 5.6.2.0, HRLD.
Wet particle size distribution was measured by a laser diffraction on a Sympatec HELOS equipped with a Quixel wet dispenser. To that end, a dry sample was added to a water-filled sample chamber until a laser obscuration level in the range of 10 to 25% was obtained. The measurement was carried out for the duration of approximately 20 seconds at 25° C.±2° C. The cuvette had a size of 6 mm.
Particle size distribution of dry potato protein samples was measured by laser diffraction using a Sympatec HELIOS equipped with a RODOS dry dispenser with a vibratory feeder. The RODOS dispersing line has an inner diameter of 4 mm.

TABLE 6
Analysis of three representative potato
protein coagulate starting materials.

| | | Protamyl 1 | Protamyl 2 | Protamyl 3 |
|---|---|---|---|---|
| PSD “wet” | d 10 (μm) | 86.6 | 36 | 44 |
| | d 50 (μm) | 250.8 | 137.4 | 159.1 |
| | d 90 (μm) | 650.7 | 321.5 | 498 |
| PSD “dry” | d 10 (μm) | 80.45 | 29.55 | 32.85 |
| | d 50 (μm) | 193.1 | 114.5 | 138 |
| | d 90 (μm) | 493 | 284.5 | 416 |

TABLE 7
Analysis of two representative purified
potato protein coagulate products.

| | | Protein starting material | |
|---|---|---|---|
| Extraction | | Protamyl | Protamyl |
| solvent medium | v % | 60% IPA | 80% EtOH |
| nr wash steps | | 2 | 2 |
| d.s. | wt % | 95.8 | 94.1 |
| KjeldahlN | % on DS | 91.3 | 90 |
| TGA | ppm on DS | 71 | 69.1 |
| crude fat | % on DS | 0.2 | <0.1 |
| PSD “wet” | d 10 (μm) | 14.3 | 41.1 |
| | d 50 (μm) | 69.2 | 160.4 |
| | d 90 (μm) | 271.5 | 397.5 |
| PSD “dry” | d 10 (μm) | 13.5 | 32.7 |
| | d 50 (μm) | 62.4 | 128.4 |
| | d 90 (μm) | 294.6 | 335.7 |

1. A method for providing a purified coagulated potato protein product containing less than 150 ppm triglycoalkaloid (TGA) and less than 1.5% based on dry solids (DS) lipids, comprising:
(i) subjecting heat coagulated potato protein to one or more extraction step(s) comprising mixing heat coagulated potato protein at a concentration of about 30-200 g/L with an alcoholic extraction solvent comprising:
(a) ethanol and water at a ratio in the range of 90:10 to 60:40 (v/v), or
(b) propanol and water at a ratio in the range of 90:10 to 40:60 (v/v), at a pH in the range of 3 to 6, under conditions allowing for extraction of glycoalkaloids and lipids from said heat coagulated potato protein composition;
(ii) washing the extracted heat coagulated potato protein with water to obtain a purified coagulated potato protein product; and
(iii) drying the purified coagulated potato protein product.

2. The method according to claim 1, wherein the extraction solvent comprises (a) ethanol and water, or (b) propanol and water, at a ratio in the range of 85:15 to 60:40 (v/v).

3. The method according to claim 2, wherein the extraction solvent comprises ethanol and water at a ratio in the range of 90:10 to 60:40 (v/v).

4. The method according to claim 1, wherein the extraction solvent comprises isopropanol (IPA) and water at a ratio in the range of 90:10 to 40:60 (v/v).

5. The method according to claim 1, wherein extraction is performed at a pH in the range of 4 to 5.

6. The method according to claim 1, wherein extraction step (i) comprises mixing the heat coagulated potato protein composition with extraction solvent at a concentration of 80-150 g/L.

7. The method according to claim 1, wherein extraction step (i) is performed at a temperature below the boiling point of the alcohol/water mixture.

8. The method according to claim 4, wherein an extraction solvent comprising 50-70 v % IPA is used at a pH in the range of 4-6.

9. The method according to claim 3, wherein an extraction solvent comprising 60-85 v % Ethanol is used at a pH in the range of 4-6.

10. The method according to claim 1, wherein the method comprises at least two consecutive extraction steps using said alcoholic extraction solvent.

11. The method according to claim 1, wherein said one or more extraction step(s) is/are performed in a continuous process or a batch wise process.

12. The method according to claim 1, wherein steps (i), (ii) and (iii) are performed on heat coagulated potato protein having a mean particle size distribution (d50) between 20 and 300 μm, as determined on a dry product.

13. The method according to claim 1, wherein the method does not comprise adjusting the pH of the extracted heat coagulated potato protein to a value of 6.5 or higher.

14. A purified coagulated potato protein product comprising:
less than 100 ppm triglycoalkaloid (TGA) based on dry solids, and
less than 0.3% lipids based on dry solids.

15. The purified coagulated potato protein product according to claim 14, having a protein concentration of at least 88% as determined by Kjeldahl.

16. The purified coagulated potato protein product according to claim 14, having:
a d10 between 5 and 70 μm, as determined on a dry product;
a d50 between 20 and 300 μm, as determined on a dry product; and/or
a d90 between 60 and 600 μm, as determined on a dry product.

17-19. (canceled)

20. The method according to claim 2, wherein the extraction solvent comprises ethanol and water at a ratio in the range of 90:10 to 70:30 (v/v).

21. The method according to claim 1, wherein the extraction solvent comprises isopropanol (IPA) and water at a ratio in the range of 90:10 to 50:50 (v/v).

22. The method according to claim 4, wherein an extraction solvent comprising 50-70 v % IPA is used at a pH in the range of 4-6 and at a temperature of 20 to 50° C.

23. The method according to claim 3, wherein an extraction solvent comprising 60-85 v % Ethanol is used at a pH in the range of 4-6 and at a temperature of 20 to 50° C.

24. The method according to claim 1, wherein steps (i), (ii) and (iii) are performed on heat coagulated potato protein having a mean particle size distribution (d50) between 25 and 250 μm, as determined on a dry product.

25. A purified coagulated potato protein product comprising:
less than 80 ppm triglycoalkaloid (TGA) based on dry solids; and
less than 0.2% lipids based on dry solids.

26. The purified coagulated potato protein product according to claim 14, having:
a d10 between 10 and 60 μm, as determined on a dry product;
a d50 between 25 and 250 μm, as determined on a dry product; and/or
a d90 between 150 and 500 μm, as determined on a dry product.
